(19) United States
(12) Patent Application Publication
(10) Pub. No.: US 2004/0267960 A1
(43) Pub. Date: Dec. 30, 2004

(54) Force master capability during multicast transfers

(75) Inventor: Linda A. Riedle, Cary, NC (US)

Correspondence Address: SAWYER LAW GROUP LLP, PO BOX 51418, PALO ALTO, CA, 94303, US

(73) Assignee: International Business Machines Corporation, Armonk, NY (US)

(21) Appl. No.: 10/603,330

(22) Filed: Jun. 25, 2003

(51) Int. Cl. G06F 15/173

(52) U.S. Cl. 709/241

(57) ABSTRACT

A method for increasing performance of a multicast network is disclosed in which a server multicasts packets to a master client and at least one passive client. Aspects of the present invention include determining, by the clients during the multicast transfer, which is a slowest client based on which client drops a highest number of packets, and making the slowest client the master client, thereby adaptively determining which client becomes the master client to minimize network traffic.

### FIELD OF THE INVENTION

The present invention is generally related to network multicast data transfers, and more particularly to a method and system for enabling clients to dynamically become the master client during a multicast transfer.

### BACKGROUND OF THE INVENTION

Data communications involves the transfer of data from one or more originating data sources (sender/server) to one or more destination data receivers (receiving client). The transfer is accomplished via one or more data links between the one or more origination data sources and destination data receivers according to a communication protocol. Thus, a data communications network comprises three or more communicating entities (e.g., origination and destination data sources) interconnected over one or more data links.

In data communications networks, messages or files are usually split into small packets to conform to the communications protocol being utilized. For typical message traffic between digital processing sender-receiver pairs in the network, an average sized message may be split into many smaller packets, and these packets are transmitted and then reassembled in the proper order at the receiving end. To keep track of the packets in such a transmission system, the packets are assigned sequence numbers at some point at the transmitting end, either by the host computer or sending terminal, or by a protocol processor downstream of the host. At the receiving end, the receiving processor keeps track of the sequence numbers and correlates incoming packet traffic by sequence numbers. The transfer system thus has to keep track of sequence numbers in a large number space (e.g., a 32-bit sequence number) so that it can track when the entire message has been transmitted and received or when packets are lost during transmission.

Traditional network transfers typically involve a single sender (server) transmitting a file to a single receiving client. This is referred to as a unicast transfer. One quickly evolving form of file transfer in the new Internet-based networks is that of multicast transfer. With a multicast transfer, a single server is able to send one copy of each packet simultaneously to a group (i.e., more than one) receiving clients. A multicast packet is a packet that is replicated and sent to multiple destination network ports.

The Trivial File Transfer Protocol (TFTP) is commonly utilized to support multicast transfer. TFTP is an Internet software utility simple transfer protocol utilized for transferring files. TFTP is utilized where user authentication and directory visibility are not required. When transferring data utilizing TFTP, the packet or block of data is sent utilizing the User Datagram Protocol (UDP) (rather than the Transmission Control Protocol) and then the sender waits for an acknowledgment (ACK) from the receiving client. When an acknowledgment is received by the sender, the next packet/block of data is sent.

As a default with TFTP, the file is sent in fixed length blocks of 512 bytes. Each data packet contains one block of data. Receipt of a data packet of less than 512 bytes signals termination of a transfer. If a packet gets lost in the network, the intended recipient will time-out and may retransmit his last packet (which may be data or an acknowledgment), thus causing the sender of the lost packet to retransmit that lost packet. The sender has to keep just one packet on hand for retransmission, since the lock step guarantees that all older packets have been received by the controlling client. The protocol's implementation of fixed length blocks makes allocations straight forward, and the lock step acknowledgment provides flow control and eliminates the need for the controlling client to reorder incoming data packets.

When a network client wishes to initiate a multicast transmission, the receiving client sends a first request with the multicast option/tag to the expected sender (server client). The server returns an acknowledgment and then begins to transmit the packets in a sequential order. The first packet is transmitted and when received by the recipient client, the recipient client generates an ACK that is transmitted to the sender. Receipt of the ACK by the sender enables the sender to then transmit the next (second) packet. In a multicast environment, several clients may simultaneously listen in on a session and receive a copy of the packets being transmitted. Typically, the first client to submit a request to begin transmission, referred to as the Master Client, is responsible for sending ACKs. The other clients may commence listening at any time during the transmission.

Upon detection of a last packet (i.e., a packet with less than 512 bytes) or occurrence of a time-out while waiting to receive the next packet, a new master client will re-open the file transfer, request specific packets that are missing, and begin sending ACKs for the packets received until it has received all the packets. Any subsequent clients can start receiving blocks of a file during a transfer and then request any missing blocks when that client becomes the master client. Once the client no longer hears packets being transferred during a time-out period, the client re-opens the session and resumes the role of the new master client by requesting missed packets.

Thus, when transmitting a file in multicast, one receiving client operates as a controlling client or master. This is typically the client that issued the request to the sender to begin transferring the file. Any number of clients may simultaneously listen in on a transfer and receive a copy of the packet(s) being transmitted. Each client receives the packet, however, only the controlling client may send an ACK indicating the correct receipt of the packet. Thus, although the other clients are listening in, they are at the mercy of the control client. Each of the other clients may also start (and stop) listening in at a different time and thus may not receive all parts of an initial transmission. Additionally, if one of the other clients does not receive the packet, (the packet is lost) that client cannot immediately re-request the packet, because it is not the controlling client. That is, the time-out condition described above occurs only for the controlling client.

When the packet is received, the client tracks the packet utilizing the sequence number included within the packet's header. This information is utilized to place the packet in its correct location in the file space so that the receiving client can track when it has received all the packets of a file and reassemble the file. To accommodate the tracing operation, current client systems are provided a 64 Kbit tracking array within their memory subsystems. When a packet is received, the sequence number is read from the packet's header and the location in the array space corresponding to the packet's sequence number is set to indicate receipt of the specific packet (e.g., the bit is set to 1). When the master client ends his transmission, another receiving client then assumes the role of the master client and begins to request the packets that were not received, as indicated by the holes in the array of the new master client.

The decision as to which client is a master client is a critical one as the following example illustrates. Assume data network includes computer A and computer B, where computer B runs twice as slow as computer A. Assume further, that both computers boot and attempt to multicast down a 2 GB file. Because system A is faster, it can be expected that computer A will boot first and request the file first and therefore become a master client. As a master client, computer A will control the rate of transfer of the file over the network. When computer B finishes booting, computer B listens on the network and becomes aware that the Multicast transfer of the file is already in progress and will therefore become a passive client, receiving whatever packets it can off of the network. Because the packets are being transmitted at the rate that computer A can handle, and computer B is twice as slow, computer B can be expected to drop half the packets.

Using theoretical numbers, assume that computer A multicast down the file as 4 million packets of size 512 bytes and ends the transfer. Computer B determines that the transfer has ended because it is still missing half its packets. Computer B reopens the transfer and requests from the server the 2 million packets it is missing. After computer B receives its missing 2 million packets, the server will have sent a total of 6 million packets over the network to complete this multicast transfer. The total time required for both computers A and B to complete the transfer is basically the time that it takes computer B to transfer its first 2 million packets followed by the time it takes to transfer the second 2 million packets. As these packets are not sequentially written to disk (i.e., the first batch of packets are written as sectors 1, 3, 5 . . . , and the second batch of packets are written as sectors 2, 4 ,6 . . . ), the total time for the file transfer is actually greater than what it would have been if computer B was initially the master client and transferred/wrote all 4 million packets sequentially.

To make matters worse, in the scenario where computer A is the master client, computer B would not even receive 2 million packets during the first multicast transfer. This is because although computer B is twice as slow as computer A under normal circumstances, computer B is even slower during packet storing because computer A is writing packets sequentially and computer B is not.

Now consider the scenario where computer B is powered on before computer A. Computer B boots up and becomes a master client and transfers down the file from the server. Almost immediately after computer B starts the multicast of the file, computer A tries to multicast the file and realizes that the multicast is in progress. In response, computer A enters passive client mode and simply listens to the multicast. Computer B transfers down 4 million packets and completes the multicast. Computer A, being twice as fast as computer B, is able to keep up with the transfer and also completes the file transfer. In this scenario, a total of 4 million packets were transferred over the network, and the time it took for both computers to complete the transfer was the time required for computer B to transfer the 4 million packets.

To support the theoretical numbers, consider actual time measurements from the following example. Assume that there are four computer systems of varying speeds, and the time it takes each system to multicast down a file standalone is as follows:

System 1—3:35 (minutes and seconds)

System 2—5:29

System 3—5:07

System 4—4:05

Now assume that the computer systems attempt to multicast the same file almost simultaneously. With system 1, the fastest, as the initial master client, the total time to complete the file transfer is 10:50. With system two, the slowest, as the initial master, the total time to complete the file transfer is 6:00. Therefore, if the slowest client in the network becomes the multicast master client, the overall network traffic and time required to multicast the file to all systems is minimized.

There appears to be two conventional methods to increase the performance of a multicast network. The first method is to place computer systems with similar speeds on different local area networks (LANs). Such a method is described in U.S. Pat. No. 6,185,623 in which slow/fast clients are divided between subnets and individual file transfers are managed on the subnets. This method, however, requires upfront network planning and management and is not adaptable in real-time.

The second method for increasing the performance of a multicast network is to have the slowest client be the master client during a multicast transfer, as suggested above. The problem is, however, how to determine which client is the slowest at any given point in time and how to make the slowest client the master client without causing too many master changes during the multicast transfer.

Accordingly, what is needed is an improved method system for increasing the performance of a multicast network. More particularly, what is needed is a method for enabling slower clients to dynamically take control of a multicast transfer in a manner that minimizes master changes. The present invention addresses such a need.

### SUMMARY OF THE INVENTION

The present invention provides a method for increasing performance of a multicast network in which a server multicasts packets to a master client and at least one passive client. Aspects of the present invention include determining, by the clients during the multicast transfer, which is a slowest client based on which client drops a highest number of packets, and making the slowest client the master client.

According to the method and system disclosed herein, the present invention enables passive clients to determine dynamically and adaptively which client becomes the master client based on performance. By enabling whichever client is slowest at any given point during the transfer to become the master, the number of dropped packets that must be resent by the server, is minimized, thereby increasing overall network performance.

### BRIEF DESCRIPTION OF THE DRAWINGS

FIG. 1 is a diagram illustrating a data processing system within which the various features of the invention may be implemented during multicast file transfer.

FIGS. 2A and 2B illustrate two configurations of a network within which the communication (i.e., data transmission) that utilizes the features of the invention occur.

FIG. 3 is a flow diagram illustrating a process for enabling slower clients to dynamically take control over a multicast transfer in accordance with the preferred embodiment of the present invention.

### DETAILED DESCRIPTION OF THE INVENTION

The present invention relates to a modification of a multicast protocol to enable clients to dynamically become master clients. The following description is presented to enable one of ordinary skill in the art to make and use the invention and is provided in the context of a patent application and its requirements. Various modifications to the preferred embodiments and the generic principles and features described herein will be readily apparent to those skilled in the art. Thus, the present invention is not intended to be limited to the embodiments shown, but is to be accorded the widest scope consistent with the principles and features described herein.

The present invention introduces a “force master” command into the multicast protocol for allowing slower clients to dynamically (in real-time) take over control of a multicast transfer. The present invention has the advantages of allowing the slowest client to drive a multicast transfer without prior knowledge of multicast group members and the relative speeds. By reducing the need for slower clients to re-request a multicast transfer to pick up missed packets, the present invention minimizes network traffic and the total time required to multicast a file to all group members.

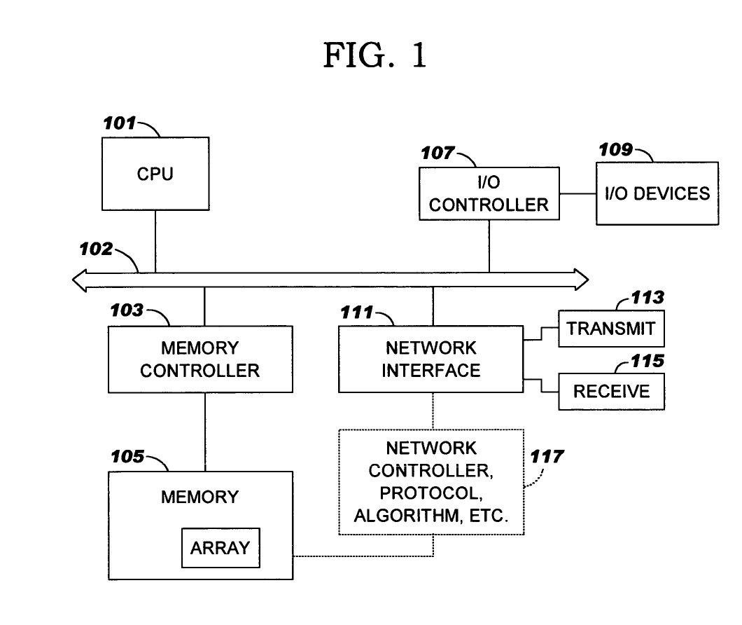

With reference now to the figures and in particular FIG. 1, there is illustrated a data processing system within which, the various features of the invention may be implemented during multicast file transfer. Data processing system 100 comprises several major components including processor (CPU) 101, memory 105, I/O devices 109, and network interface 111. These major components are generally interconnected via system bus 102. Memory 105 is connected to the other components through memory controller 103 and, likewise, I/O devices 109 are connected through I/O controller 107. As illustrated, network interface 111 includes two ports, transmit port 113 and receive port 115, which provide the hardware and logic required for the physical connection to an external network. Transmit port 113 and receive port 115 respectively transmit and receive data packets and ACKs during multicast file transmission as further described below. Thus, these components enable data processing system 100 to operate either as the source or the destination of the messages/files transmitted within an interconnected network. Although illustrated with specific components in a particular configuration, the present invention may be implemented within other systems, which may not be standard data processing systems and/or other data processing systems comprising different/additional components and configurations.

To enable proper network communication, data processing system 100 typically includes a network controller 117 (i.e., an adapter or other facility) for executing the network protocol. In some cases the protocol can be executed on the host computer itself, but this task may be offloaded to a protocol processor. According to the preferred embodiment, a Trivial File Transfer Protocol (TFTP) is utilized within data processing system and the network (described below) to enable transmission of data packets, ACKs, etc., although other multicast protocols may also be used.

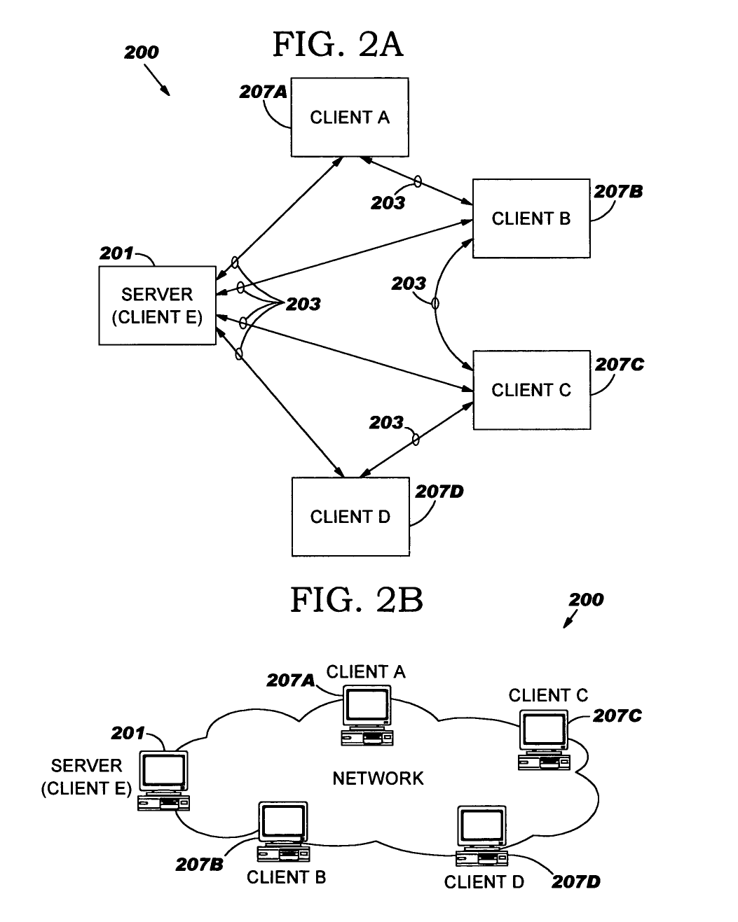

FIGS. 2A and 2B illustrate two configurations of network 200 within which the communication (i.e., data transmission) that utilizes the features of the invention occur. Network is illustrated having a sender/server 201, which is interconnected to clients 207A-207D via network links 203. Server 201 and clients 207A-207D may each comprise data processing system 100 or a similar hardware configured system that executes the various processes provided by the invention during receipt of packages of a file. Each server and/or client includes the hardware and software required to complete network transmissions via file transfer protocol and multicast data packet transfer. The transfer of data over the network is completed utilizing a network protocol, which in the preferred embodiment, is a trivial file transfer protocol (TFTP). According to the preferred embodiment of the invention, network 200 operates as a multicast environment that supports data transfer via TFTP.

For illustration, when describing a multicast transmission herein, server 201 is assumed to be the sender/originator of the data packets and clients 207A-207D are assumed to be the recipients of the data packets. Of course, receipt of the data packets may occur simultaneously, with any one of the receiving clients operating as the master (i.e., the client that requests the transmission and which is responsible for sending ACKs in response to receipt of each packet) according to multicast TFTP transfer guidelines. In the illustrated multicast network, server 201 is a similar processing system to the other clients 207A-207D, and can therefore operate as a receiver of data packets from another one of the clients, which then assumes the role of the server (i.e., sender).

In FIG. 2A, the client systems 207A-207D are illustrated interconnected via links 203. Although illustrated as single, point-to-point connections, these links 203 may include a number of links connecting intermediate nodes, and some of these links 203 may ordinarily be trunk facilities, capable of simultaneous or time-multiplexed transmission of hundreds or thousands of separate channels or messages. Links 203 may comprise microwave or satellite link, or fibre optic link, as well as conventional wiring. Network 200 may be a local network or may be a geographically dispersed network spanning hundreds or thousands of miles.

Also, in the communications network 200, alternative paths may exist between clients (server and clients) for a packet sent from server 201 to clients 207A-207D, so that packets of a given file may be routed from server 201 to receiving clients 207A-207D by different routes. As is typically the case, network traffic is routed by paths having available bandwidth, according to the level of congestion existing from moment to moment within various links in the network. Thus, a message having a number of packets may have packets routed by diverse links 203, and some packets may never arrive at the destination client (i.e., packets get lost).

The message packets could be of various formats, depending upon the protocol being executed and the transport mechanism. According to TFTP, each 512 byte packet has a header comprising a unique sequence number (ranging from 1 to 2³²−1 in the preferred embodiment) selected by a processor at the sending/transmitting end (e.g., server 201), identifying this packet as to its position in a file. For example, if the complete message is 32 KBytes, and each packet carries 512 bytes in its data field, then sixty-five packets numbered 1 through 65 are generated to transmit the file.

The present invention provides a process for enabling slower clients to dynamically take control over a multicast transfer. The present invention provides clients 207 with an algorithm that allows the clients 207 to adaptively determine in real-time which client becomes the master client. In a preferred embodiment, the determination of which client 207 is the slowest is based on which client 207 drops the most number of packets during the multicast transfer. More specifically, the determination of the slowest client 207 is calculated based on the drop ratio of each client 207. The algorithm continuously calculates the number of packets the client 207 drops during the transfer. Once this drop ratio passes a configurable threshold, the client 207 issues a “force master” command, which causes the server 201 to recognize that client 207 as the master client, and allows the client 207 to dynamically take control over the transfer. By allowing the slowest client 207 at any given time to maintain control over the multicast transfer, the algorithm of the present invention minimizes network traffic and the time required to multicast a file to all group members. In addition, basing the slowest client determination on a packet drop ratio minimizes the number of master changes required during the transfer.

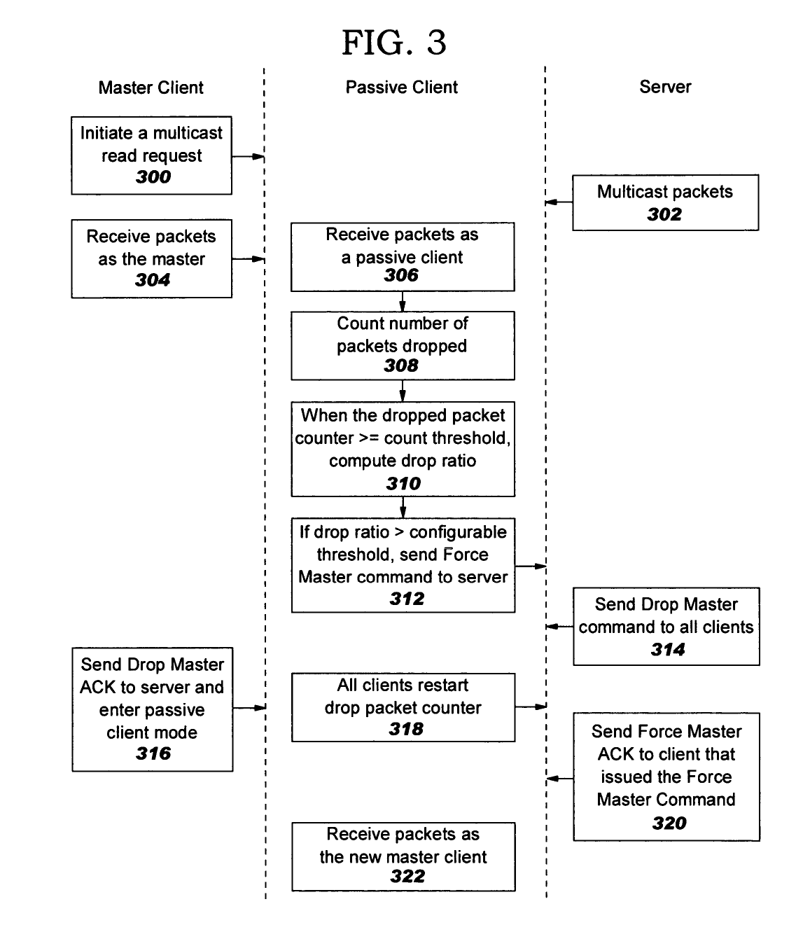

FIG. 3 is a flow diagram illustrating a process for enabling slower clients to dynamically take control over a multicast transfer in accordance with the preferred embodiment of the present invention. The process begins in step 300 when a client 207 initiates a multicast read request for a file from the server 201. In step 302, the server 201 receives the request and starts transmitting packets. In step 304, the client 207 that initiated the request begins receiving packets as the master client. In step 306, any client 207 on the network that desires the same file begins receiving the packets as a passive client.

According to the present invention, the adaptive algorithm running in the passive clients begins counting the number of packets dropped in step 308. When the dropped packet counter reaches a count threshold, the algorithm computes a drop ratio in step 310. In step 312, if the drop ratio reaches a configurable threshold, then the client 207 sends a Force Master command to the server 201. According to the present invention, the Force Master command is a signal to the server 201 that a client 207 requests that it be designated the new master client.

The count threshold and the drop ratio threshold depend on the configuration and context of the network. As one example, however, the clients 207 could be programmed to calculate the drop ratio once 100 packets are dropped, and issue the Force Master command when the drop ratio reaches 25 percent (i.e., if between packet X and packet X+99, the client only processes 75 packets).

In response to receiving the Force Master command, the server 201 sends a Drop Master command to all clients 207 in the multicast group in step 314. The Drop Master command is a signal to the current master to relinquish control of the transfer.

In step 316, when the current master client receives the Drop Master command, the current master sends a Drop Master acknowledge to the server 201 and enters passive client mode. In step 318, in response to receiving the Drop Master command, all passive clients 207 restart their dropped packet counters. In an alternative embodiment, the server 201 could send the Drop Master command directly to the current master, and send another command to all clients 207 instructing them to restart their drop ratio counters.

In step 320, the server 201 sends a Force Master acknowledge to the client 207 that issued the Force Master command. And in step 322, the client 207 that initiated the Force Master command begins receiving the packets from the server 201 as the new master client.

A method for increasing the performance of a multicast network has been disclosed that dynamically gives the slowest client in the multicast group control over the transfer, thereby minimizing network traffic and time required to multicast a file to the clients in the multicast group in a manner that minimizes master changes.

The present invention has been described in accordance with the embodiments shown, and one of ordinary skill in the art will readily recognize that there could be variations to the embodiments, and any variations would be within the spirit and scope of the present invention. Accordingly, many modifications may be made by one of ordinary skill in the art without departing from the spirit and scope of the appended claims.

What is claimed is

1. a method for increasing performance a multicast network in which a server multicast packets to a master client and at least one passive client, the method comprising the steps of:
(a) determining, by the clients during the multicast transfer, which is a slowest client based on which client drops a highest number of packets; and
(b) making the slowest client the master client, thereby adaptively determining which client becomes the master client to minimize network traffic.

2. The method of claim 1 wherein step (a) further includes the step of:
(i) counting, by the passive client, a number of dropped packets during a multicast transfer;
(ii) computing a drop ratio when the count of the number of dropped packets reaches a predetermined count threshold; and
(iii) if the drop ratio reaches a configurable threshold, sending a Force Master command to the server requesting to become a new master client.

3. The method of claim 2 wherein step (b) further includes the step of:
(i) in response to the server receiving the Force Master command, sending a Drop Master command from the server to the master client.

4. The method of claim 3 wherein step (b) further includes the step of:
(ii) sending from the master client to the server a Drop Master acknowledgement and causing the master client to enter passive client mode.

5. The method of claim 4 wherein step (b) further includes the step of:
(iii) restarting the drop packet counter in the passive client after the Drop Master command has been sent from the server.

6. The method of claim 5 wherein step (b) further includes the step of:
(iv) sending from the server a Force Master acknowledge to the passive client that issued the Force Master command.

7. A method for increasing performance a multicast network in which a server multicast packets to a master client and at least one passive client, comprising the steps of:
(a) counting, by the passive client, a number of packets dropped during a multicast transfer;
(b) computing a drop ratio when the count of the number of packets dropped reaches a predetermined count threshold; and
(c) if the drop ratio reaches a configurable threshold, sending a Force Master command to the server requesting to become a new master client, thereby adaptively determining which client becomes the master client in real-time.

8. The method of claim 7 further including the step of:
(d) in response to the server receiving the Force Master command, sending a Drop Master command from the server to the master client.

9. The method of claim 8 further including the step of:
(e) sending from the master client to the server a Drop Master acknowledgement and causing the master client to enter passive client mode.

10. The method of claim 9 further including the step of:
(f) restarting the drop ratio counter in the passive client after the Drop Master command has been sent from the server.

11. The method of claim 10 further including the step of:
(g) sending from the server a Force Master acknowledge to the passive client that issued the Force Master command.

12. The method of claim 11 further including the step of:
(h) after the passive client receives the Force Master acknowledge, receiving the packets from the server as the new master client.

13. A multicast network system, comprising
a server for multicasting packets over the network;
a current master client that controls the multicast transfer of the packets; and
at least one passive client executing an algorithm for:
(a) counting a number of packets dropped during a multicast transfer;
(b) computing a drop ratio when the count of the number of packets dropped reaches a predetermined count threshold; and
(c) if the drop ratio reaches a configurable threshold, sending a Force Master command to the server requesting to become a new master client, thereby adaptively determining which client becomes the master client in real-time.

14. The system of claim 13 wherein in response to the server receiving the Force Master command, sending a Drop Master command from the server to the master client.

15. The system of claim 14 wherein from the master client sends a Drop Master acknowledgement to the server and enters passive client mode.

16. The system of claim 15 wherein the passive client restarts the drop ratio counter after the Drop Master command has been sent from the server.

17. The system of claim 16 wherein the server sends a Force Master acknowledge to the passive client that issued the Force Master command.

18. The system of claim 17 wherein after the passive client receives the Force Master acknowledge, the passive client receives the packets from the server as the new master client.

19. A computer-readable medium containing program instructions for increasing performance a multicast network in which a server multicast packets to a master client and at least one passive client, the program instructions for:
(a) determining, by the clients during the multicast transfer, which is a slowest client based on which client drops a highest number of packets; and
(b) making the slowest client the master client, thereby adaptively determining which client becomes the master client to minimize network traffic.

20. The computer-readable medium of claim 19 wherein instruction (a) further includes the instruction of:
(i) counting, by the passive client, a number of packets dropped during a multicast transfer;
(ii) computing a drop ratio when the count of the number of packets dropped reaches a predetermined count threshold; and
(iii) if the drop ratio reaches a configurable threshold, sending a Force Master command to the server requesting to become a new master client.

21. The computer-readable medium of claim 20 wherein instruction (b) further includes the instruction of:
(i) in response to the server receiving the Force Master command, sending a Drop Master command from the server to the master client.

22. The computer-readable medium of claim 21 wherein instruction (b) further includes the instruction of:
(ii) sending from the master client to the server a Drop Master acknowledgement and causing the master client to enter passive client mode.

23. The computer-readable medium of claim 22 wherein instruction (b) further includes the instruction of:
(iii) restarting the drop ratio counter in the passive client after the Drop Master command has been sent from the server.

24. The computer-readable medium of claim 23 wherein instruction (b) further includes the instruction of:
(iv) sending from the server a Force Master acknowledge to the passive client that issued the Force Master command.
